(19) United States
(12) Patent Application Publication
(10) Pub. No.: US 2016/0200601 A1
(43) Pub. Date: Jul. 14, 2016

(54) Aquatic Environment Additive Dosing Apparatuses and Systems, and Methods and Software Therefor

(71) Applicant: STEP AHEAD INNOVATIONS, INC., South Burlington, VT (US)

(72) Inventor: James E. Clark, South Burlington, VT (US)

(73) Assignee: Step Ahead Innovations, Inc., South Burlington, VT (US)

(21) Appl. No.: 14/771,491

(22) PCT Filed: Mar. 15, 2014
(86) PCT No.: PCT/US14/30077

§ 371 Date: Aug. 29, 2015

Related U.S. Application Data
(60) Provisional application No. 61/798,315, filed on Mar. 15, 2013.

(51) Int. Cl. C02F 1/68

(52) U.S. Cl. CPC C02F 1/68; C02F 2209/005

(57) ABSTRACT

A dosing system and method for adding an additive to an aquatic environment from a removable additive container that includes an additive-identification device. The dosing system also includes an additive-presence-detecting device designed and configured to interface with the additive-identification device of the removable additive container so as to identify the additive of the additive container. A controller uses a dosing signal and to the identity of the additive by the additive-presence detecting device so as to control a dispensing mechanism to controllably dispense a desired additive. A plurality of additive receivers may be included in a dosing system such that an additive in each additive receiver can be identified properly by such a dosing system.

### RELATED APPLICATION DATA

This application claims the benefit of priority of U.S. Provisional Patent Application Ser. No. 61/798,315 filed Mar. 15, 2013, and titled “Aquatic Environment Additive Dosing Apparatuses and Systems, and Methods and Software Therefor,” which is incorporated by reference herein in its entirety.

### FIELD OF THE INVENTION

The present invention generally relates to the field of maintaining water quality in aquatic environments. In particular, the present invention is directed to aquatic environment additive dosing apparatuses and systems, and methods and software therefor.

### BACKGROUND

Maintaining the quality of water is important in a wide variety of circumstances. For example, for keeping fish and/or other aquatic life, the quality of the water must be kept within certain tolerances to keep the aquatic life healthy. As another example, the water in swimming and diving pools, hot tubs, and other sports, recreational, and therapeutic bodies of water needs to be kept at certain levels of quality not only to maintain that water's clarity, but also to keep the users of these bodies of water safe from waterborne illnesses and/or overexposure to treatment chemicals. As yet another example, the quality of potable water needs to be maintained within a range of tolerances as to a variety of chemical constituents for any one or more of a number of reasons, such as to make the water safe for ingesting, less harmful to distribution systems, and to promote healthfulness of the drinkers (e.g., in the case of adding fluorine and/or other nutrients). Those skilled in the art will readily appreciate that these are but a few examples of settings in which it is important to maintain and/or control the quality of water.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a high-level block diagram of a dosing system made in accordance with various aspects of the present invention;

FIG. 2 is a high-level block diagram of a multi-receiver doser made in accordance with various aspects of the present invention;

FIG. 3 is an isometric view of multi-receiver doser engaged with an aquarium-system sump;

FIG. 4 is an enlarged rear isometric view of the multi-receiver doser of FIG. 3, showing a subset of the components of the doser;

FIG. 5 is an enlarged isometric cross-sectional view of one of the dispensing stations of the multi-receiver doser of FIG. 3;

FIG. 6A is an enlarged isometric view of a dispensing rod that can be used with a doser of the present disclosure, such as the multi-receiver doser of FIG. 3;

FIG. 6B is another view of the dispensing rod of FIG. 6A;

FIG. 7A is an enlarged isometric cross-sectional view of a dispensing bin that can be used with a doser of the present disclosure, such as the multi-receiver doser of FIG. 3;

FIG. 7B is another view of the dispensing bin of FIG. 7A;

FIG. 8 is an enlarged top isometric view showing a pair of the dispensing bins of the multi-receiver doser of FIG. 3, with one of the dispensing bins containing an additive container and the other not containing an additive container;

FIG. 9 is an enlarged top isometric view of a pair of the receivers of the multi-receiver doser of FIG. 3, with one of the receivers engaged by a dispensing bin and the other not engaged by a dispensing bin;

FIG. 10 is an enlarged elevational back view of the multi-receiver doser of FIG. 3 showing a suspended dosing-mechanism support suitable for use in a weight system for weighing the amount of additive dispensed and/or present in the doser;

FIG. 11 is a vertical cross-sectional view of an additive container and dispensing bin arrangement that utilizes a radio-frequency identification system for identifying the additive in the additive container to a dosing system;

FIG. 12 is a vertical cross-sectional view of a discretizing dispenser suitable for use with a dosing system of the present disclosure;

FIG. 13A is a partial cross-sectional view of a linear dispensing mechanism suitable for use with a dosing system of the present disclosure, showing the dispensing bar in a fill position;

FIG. 13B is a partial cross-sectional view of the linear dispensing mechanism of FIG. 13A, showing the dispensing bar in a dispensing position;

FIG. 14 is a partial cross-sectional view of a multi-switch system that can be used in an additive-identification system of the present disclosure;

FIG. 15 is an elevational view of a dispensing cap for a liquid container that is usable with an intelligent dosing system of the present disclosure;

FIG. 16 is a high-level block diagram illustrating a computing system that can be used to implement any one or more of the automated aspects, features, methodologies of the present disclosure; and

FIG. 17 is another example of a dispensing rod for use is a dosing system of the present disclosure.

### DETAILED DESCRIPTION

The present disclosure is directed to, among other things, systems, devices, and apparatuses and various methods and software relating thereto for dosing one or more additives to any of a wide variety of aquatic environments, such as the aquatic environments listed above and addressed in U.S. patent application Ser. No. 13/713,495, filed on Dec. 13, 2012, and titled “SUBMERSIBLE CHEMICAL INDICATOR APPARATUSES FOR USE IN AQUATIC-ENVIRONMENT MONITORING/MEASURING SYSTEMS”, which is incorporated herein for its disclosure of: aquatic environments that are dosed with additives; monitoring apparatuses, systems, methods, and software; automated and manual dosing, including dosing calculators, systems, apparatuses, methods, and software, both with and without automated monitoring; as well as computing platforms and networks that may be utilized with the dosing systems, devices, and apparatuses and various methods and software of the present disclosure. A number of exemplary aspects and embodiments of these systems, devices, and apparatuses and various methods and software are described below. However, those skilled in the art will understand that these examples are merely illustrative and that many variations are possible and that such variations can readily be made by skilled artisans using the foundational teachings of this disclosure.

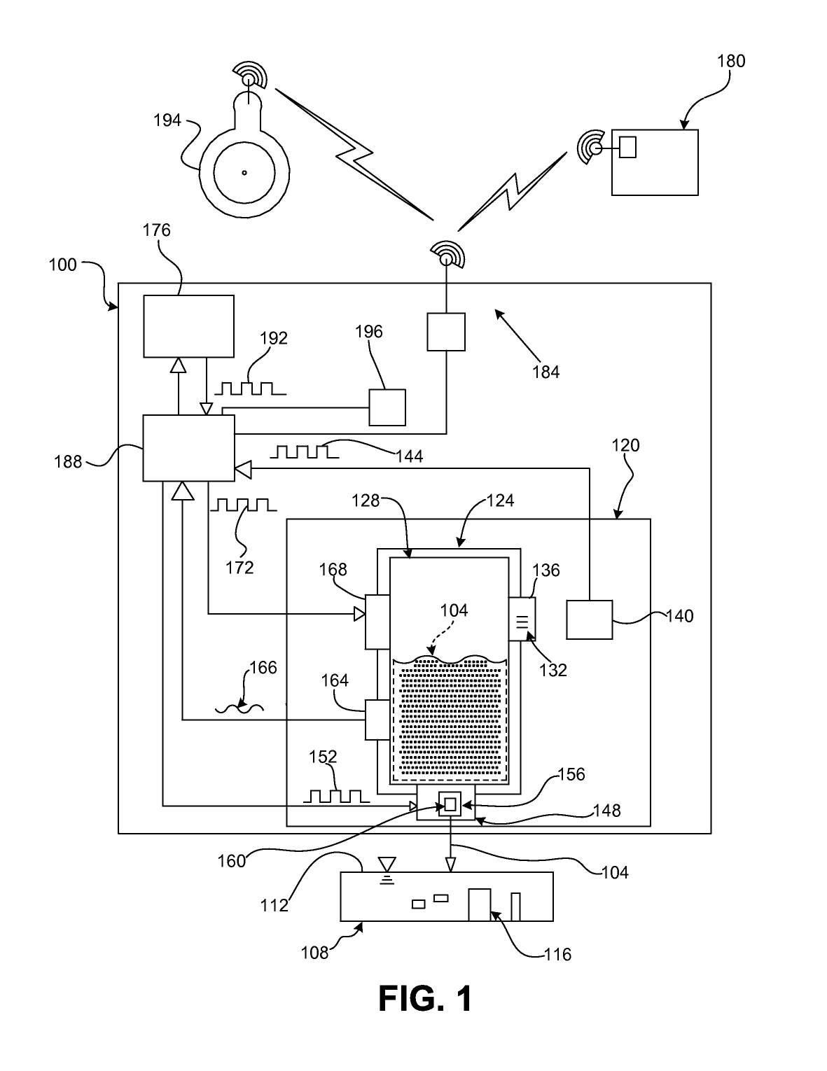

With that in mind, FIG. 1 illustrates an exemplary dosing system 100 suitable for dosing an additive 104 to an aquatic environment 108 that contains water 112 and perhaps one or more life forms or other matter 116, such as inanimate objects, that are subjected to the water. As those skilled in the art will readily appreciate, additive 104 can be any of a wide variety of additives that may be needed by aquatic environment 108, for example, to maintain the quality and/or character of water 112 and/or to maintain and/or foster the one or more life forms or other matter 116 located within the water or is otherwise subjected to the water. Examples of additives include, but are not limited to, calcium, iron, trace minerals, iodine, potassium, animal food, plant food, fertilizer, magnesium, carbonate hardness, pH/pOH adjusters, medicinal additives, therapeutic additives, etc. In the context of dosing system 100, additive 104 can be in any suitable form, such as: a particulate (granulated, powdered, flaked, ground, rolled, milled, extruded and discretized, crushed, or otherwise discretized into particles); a liquid, including dispersions; and a gel, among others. Generally, the form of additive 104 is immaterial to the high-level functionality of dosing system 100. Those skilled in the art and working with a particular type of aquatic environment will readily understand the additives needed for a particular application and that would, therefore, be suitable for use as additive 104 for that application. As noted above, there is generally no fundamental constraint on what aquatic environment 108 is other than practicalities relating to its size and the sizes of components of dosing system 100 and the ability of the dosing system to effect a meaningful change to the aquatic environment. It is noted that the term “aquatic environment” as used herein and in the appended claims includes not only the aquatic environment per se (such as an aquarium, swimming pool, hot tub, etc.), but also any appurtenance (e.g., sump, mixing chamber, etc.) and/or aquatic environment maintenance system (e.g., filter system, recirculation system, feed-water system, makeup-water system, etc.) that contains water 112 that is from the actual aquatic environment and/or is destined for the actual aquatic environment.

Dosing system 100 comprises a doser 120 that includes a receiver 124 adapted to receive an additive container 128 that contains additive 104. In this example, container 128 is removably engaged with receiver 124. In one example, container 128 may be either a prepackaged additive container, such as one that a user purchases from a suitable source, or a user-filled container to which the user adds her/his own additive. In either case, identifying information 132 about additive 104 and the presence of the additive in doser 120 are automatedly known and/or discovered by dosing system 100 in any of a variety of ways, many of which are detailed herein. With this intelligence about additive 104, dosing system 100 can make appropriate decisions and/or take appropriate actions, as will be described below.

To facilitate this intelligence, additive container 128 includes an additive-identification device 136, and doser 120 includes a corresponding additive-presence-detecting device 140 that interfaces with the additive-identification device on or proximate to the additive container to achieve the requisite intelligence. As used herein and in the appended claims, the term “interface,” and its differing parts of speech and plurals, denote that additive-identification device 136 is specifically designed for use with additive-presence-detecting device 140 and is designed so that the additive-identification device is encoded with information that identifies additive container 128 and/or its contents or intended contents to doser 120 and/or another part of dosing system 100. In its simplest form, such encoding of information can simply be accomplished via a conformal mating fit between additive container 128 (wherein the unique shape of the container provides the additive-identification device 136) and doser 120 (wherein the matching mating shape of a portion of the doser provides the additive-presence-detecting device 140) and/or a keyed fit between a physical structure on container (i.e., the additive-identification device) and a physical structure on doser 120 (i.e., the additive-presence-detecting device). In more complex forms, such encoding of information can be the encoding of information so that it is readable via a suitable reader (i.e., additive-presence-detecting device 140) electronically (e.g., in a solid-state memory), magnetically (e.g., in a magnetic medium), optically (e.g., as a bar code, matrix code, text, etc.), or haptically (e.g., pattern of raised features, recessed features, a combination of raised and recessed features, etc.), among others. In the context of readable encodings, the readable device, i.e., additive-identification device 136, would be, in those examples and respectively, a device containing the solid-state memory (such as a radio-frequency identification (RFID) device), a device containing the magnetic medium (such as a magnetic strip), a device containing the optically readable information (such as a printed label), and the haptically readable structure (such as one or more features formed into additive container 128 of on an attachment that is secured to the container after the container is formed or as it is being formed or is otherwise associated with the container, such as through a keying system). Examples of readers that are suitable for additive-presence-detecting device 140 include, but are not limited to, RFID readers, magnetic readers, optical readers (e.g., laser scanner based, photosensor-based, etc.), and haptic readers (e.g., switch-array based). Whatever reader is used for additive-presence-detecting device 140, the reader can output a suitable reader signal 144 that signals the presence of additive 104 (or at least a container that is supposed to contain the additive) and/or provide specific information that identifies the additive and/or its various attributes that may be needed to determine proper dosages of the additive. Those skilled in the art will readily understand the variety of forms that additive-identification device 136 and additive-presence-detection device 140 can take, especially in view of examples presented herein.

In this example, doser 120 includes a dispensing system 148 that dispenses additive 104 in response to a dosing signal 152. Dispensing system 148 includes one or more dispensing mechanisms 156 that carry out the physical dispensing of additive 104 into aquatic environment 104 and one or more actuators 160 that drive the one or more dispensing mechanisms in response to dosing signal 152. Each dispensing mechanism 156 can be any of a number of dispensing mechanisms, such as, but not limited to, a rotary mechanism (e.g., dispensing-receptacle type, and auger type), a valve mechanism (rotary, gate, ball, etc.), a linearly movable receptacle mechanism, a grinding mechanism, and a grating mechanism, among others, and any combination thereof. There is fundamentally no limitation on the type of dispensing mechanism(s) that can be used in dispensing system 148, as long as each dispensing mechanism selected is suitable for the particular type of additive 104. Exemplary actuators that can be used for actuator 160 include, but are not limited to, rotary motors, pneumatic actuators, hydraulic actuators, piezoelectric actuators, etc., and any combination thereof, with or without any connecting transmission (such as a reduction gear-type transmission) and/or without any connecting mechanical linkages. Several embodiments of dispensing systems suitable for use as dispensing system 148 are described herein. However, these embodiments are not to be considered limiting but rather as illustrations. As illustrated by specific examples presented herein, components of dispensing system 148, such as dispensing mechanism(s) 156, actuator(s) 160, and parts thereof, can be located and arranged as parts of or appurtenances to doser 120 or additive container 128, or both.

Doser 120 can optionally include an additive-quantity-sensing system 164 that can sense and/or collect information for determining the amount of additive 104 contained in additive container 128 and/or the amount of additive dispensed from dispensing system 148 during dispensing operations. Examples of sensing systems suitable for use as additive-quantity-sensing system 164 include weighing systems (e.g., load-cell based), optical systems (level sensing, flow sensing), volumetric systems, flow meters, and level indicators (e.g., float based, sonic-sensor based, capacitive-sensor based, etc.), among others. Fundamentally, there is no limitation on the type of system that can be used for additive-quantity-sensing system 164. An exemplary suspended structure for a load-cell based weighing system is described below in connection with FIG. 8.

Doser 120 and/or additive container 128 can optionally include a dispensing-assistance system 168 that assists in the dispensing of additive 104 from the additive container. Examples of dispensing-assistance systems that can be used for dispensing-assistance system 168 include, but are not limited to, vibrators (e.g., piezoelectric, eccentric mass, etc.) that assist with flow of flowable solid forms of additives, advancing mechanisms that push or otherwise move solid-form additives into a grinder, shaver, etc., and mixers that mix additives that have components that tend to separate over time but that need to be well-mixed before dispensing. As with dispensing system 148, various components of dispensing-assistance system can be located and arranged as parts of or appurtenances to doser 120, additive container 128, receiver 124, or any combination thereof. Dispensing-assistance system 168, if present, can be controlled via a suitable dispensing-assistance control signal 172.

Dosing system 100 can be controlled in any of a number of ways to cause it to dispense the proper dosage of additive 104 into aquatic environment 108. For example, dosing system 100 can be controlled “manually” by a user inputting information into a suitable user interface 176 that can either be part of doser 120 or located off-board of the doser on a suitable external device 180, such as a general computing device (e.g., a smartphone, tablet computer, laptop computer, desktop computer, etc.) or a dedicated controller device, among others. If user interface 176 is located on an external device 180, the external device may be in communication with doser 120 via any suitable communications system 184, such as a network, a wired system (e.g., universal serial bus system, FIREWIRE® system, etc.) or a wireless system (BLUETOOTH® system, WI-FED system, piconet radio system, etc.), and any combination thereof. In one example, user interface 176 may require a user to input one or more dosing parameters, such as amount of additive, dosing rate, dosing period of time, etc. In another example, user interface 176 may have a certain level of intelligence, such as water volume and desired level of the affected water constituent, that only requires a user to input the current level of that constituent. In both of these examples, the user may have determined the input information from performing water testing manually or using a monitoring device that is not integrated with dosing system 100.

Depending on the level of standalone functionality that doser 120 may have, it may include an onboard processing system 188 that provides the necessary functionality, such as generating dosing signal(s) 152 and/or dispensing-assistance control signal(s) 172 as a function of user input signal(s) 192 (if any), reader signal(s) 144 (if any), and additive-quantity-sensing signal 166 (if any), among other input. As will be readily understood by skilled artisans, onboard processing system 188 can include any of a variety of known components, such as microprocessors, systems-on-chips, application specific integrated circuits, and supporting circuitry and systems. If included, onboard processing system 188 can be in communication with communications system 184. Onboard processing system 188 may be part of a controller associated with a dosing system, such as dosing system 100. A controller may be distributed across one or more devices associated with a dosing system (e.g., an aquatic environment monitor 194) and/or one or more components of a dosing system (e.g., portions of a controller may be distributed across a plurality of processing elements, each associated with a corresponding additive receiver). In such a distributed controller, a controller may include one or more processing elements.

In other examples, the one or more dosing parameters may come from a water-quality monitoring system 194 or other device (such as a feeding timer, among others) located off-board of doser 120. Examples of a water-quality monitoring system suitable for use as monitoring system are described in U.S. patent application Ser. No. 13/713,495, filed on Dec. 13, 2012, and titled “SUBMERSIBLE CHEMICAL INDICATOR APPARATUSES FOR USE IN AQUATIC-ENVIRONMENT MONITORING/MEASURING SYSTEMS”, which as indicated above is incorporated herein by reference in its entirety for the disclosure of such monitoring systems. To facilitate use of such automated water-quality monitoring system, dosing system 100 of FIG. 1 can include a dosing calculator 196 that can generate dosing signal 152 based on information from the monitoring system. Examples of dosing calculators that are suitable for use as dosing calculator 196 are described in U.S. patent application Ser. No. 13/713,495, filed on Dec. 13, 2012, and titled “SUBMERSIBLE CHEMICAL INDICATOR APPARATUSES FOR USE IN AQUATIC-ENVIRONMENT MONITORING/MEASURING SYSTEMS”, which as indicated above is incorporated herein by reference in its entirety for the disclosure of such dosing calculators.

Depending on the types of additive-identification device 136 and additive-presence-detecting device 140 used, dosing system 100 can work in a variety of ways. For example, if additive-identification and additive-presence-detecting devices 136 and 140 are uniquely keyed or mating parts so that only a specific type of additive 104 can be used, then dosing system 120 ensures that the proper additive 104 is being used simply by the fact that the unique keyed-engagement or conformal-engagement of additive container 128 with doser 120 allows only the proper additive container to be installed into the doser. It is noted that in this non-intelligent system, additive-presence-detecting device 140 could include a removable keyed or conformal receptacle (not shown, but see FIG. 8) that a user could replace so that differing additives could be used with doser 120 having only one receiver 124. As also illustrated below in connection with FIG. 8, such an unintelligent system could be made intelligent by providing the removable additive receptacle, for example, additive container, with a readable device, such as any of the radio frequency, magnetic, optical, and haptic devices, encoding with information identifying the additive that mates with that receptacle. Then, doser 120 could be augmented with a corresponding reader (not shown) that essentially functions as an intelligent additive-presence-detecting device like the readers described above in connection with additive-presence-detection device 140.

In contrast to the non-intelligent example provided above, when additive container 128 includes a readable additive-identification device 136 and additive-presence-detection device 140, the additive-presence-detection device 140 can read the readable additive-identification device and provide reader signal 144 to a component of dosing system 100 that can use the information about additive 104 that the reader signal conveys, such as processing system 188 (if present) or dosing calculator 196 (if present). As an example, one can envision an aquatic-environment setup in which multiple like dosers, each similar to doser 120 of FIG. 1, are used for dosing multiple additives that are available in prepackaged form in additive containers that are the same except for the labels, the additives that they contain, and the information that the like additive-identification devices secured to the containers are encoded with. Consequently, in this example, all of the dosers are the same, and each container can be engaged with any of the dosers. With each additive container having its own readable additive-identification device that uniquely identifies the corresponding additive, the dosing system, for example, via a dosing calculator, processing system, or both, determined from the corresponding respective additive-presence-detection devices (i.e., readers) which additive is in which doser. For dosing, the dosing system can then use this intelligence to control the proper dosages of the differing additives by sending the dosing signals to the appropriate dosers as needed.

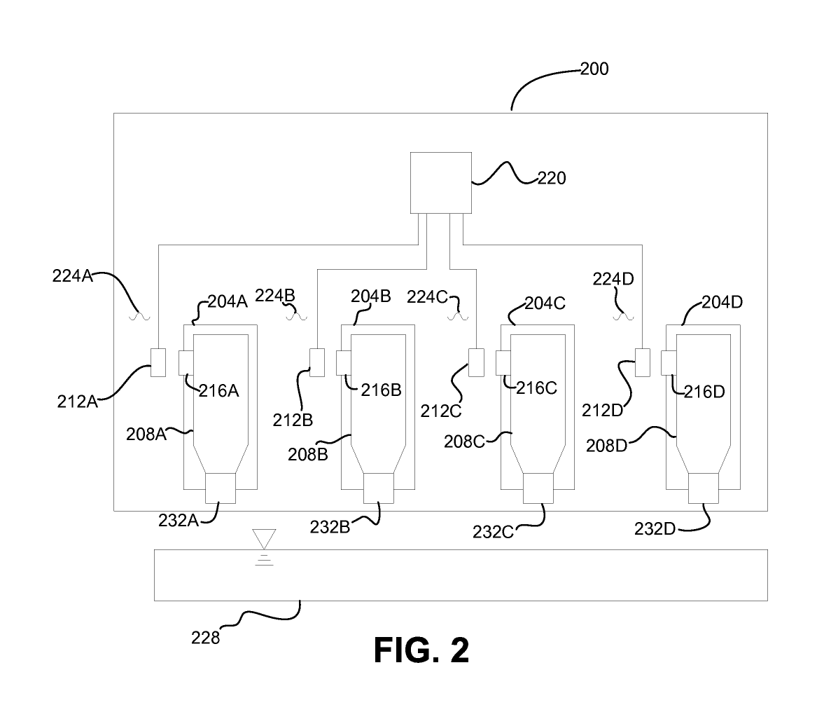

In connection with the foregoing example of multiple dosers, FIG. 2 illustrates an exemplary multi-receiver doser 200 having four receivers 204A to 204D that are identical to one another and are configured to receive additive containers 208A to 208D that can contain any additive. Like the foregoing multi-doser example, each receiver has a corresponding reader 212A to 212D that functions as an additive-presence-detector and is capable of reading the corresponding additive-identification device 216A to 216D. Readers 212A to 212D can be of any suitable type, such as radio frequency, magnetic, optical, haptic, switch matrix, etc., and all can be of the same type so that additive containers 208A to 208D are interchangeable among receivers 204A to 204D. Correspondingly, additive-identification devices 216A to 216D are of a type that is readable by readers 212A to 212D. Generally, the only thing that differs among the containers when they contain differing additives (including the same additives, but of differing concentrations or form (e.g., liquid versus solid)) is the encoding of additive identification devices 216A to 216D to contain information concerning the particular additive in each container. Of course, any label that each additive container 208A to 208D may have (especially if bought prepackaged) for informing a human user as to the content, would typically be different, too.

Those skilled in the art will appreciate the many ways that multi-receiver doser 200 and like multi-receiver dosers can be used. For example, if four or fewer differing additives are needed to be at the ready at all times, those additives can be kept in multi-receiver doser 200 at all times so that they are always available when needed. If a particular type of additive is needed much more than others, two or more of receivers 204A to 204D can be populated with the same additive at the same time. Multi-receiver doser 200 or any dosing controller, such as dosing controller 220 that controls the dosing operations of the doser, will automatically know which additive is in which receiver 204A to 204D as a result of appropriate signals 224A to 224D from readers 212A to 212D upon reading additive-identification devices 216A to 216D. In yet another example, if the aquatic environment at issue, here aquatic environment 228, requires a temporary prescriptive additive in addition to regular-dosing additives, such temporary additive can be provided by installing the appropriate additive container(s), for example, one or more of additive containers 208A to 208D, into any of the four receivers 204A to 204D and, via the corresponding ones of readers 212A to 212D and the respective additive-identification device(s) of the container(s), dosing controller 220 will know which dosing mechanism(s) 232A to 232D to operate for the prescriptive dosing with the temporary prescriptive additive(s). After the prescriptive dosing has been completed, a user can remove the prescriptive additive container(s) and replace any of the regular-dosing additive container as necessary.

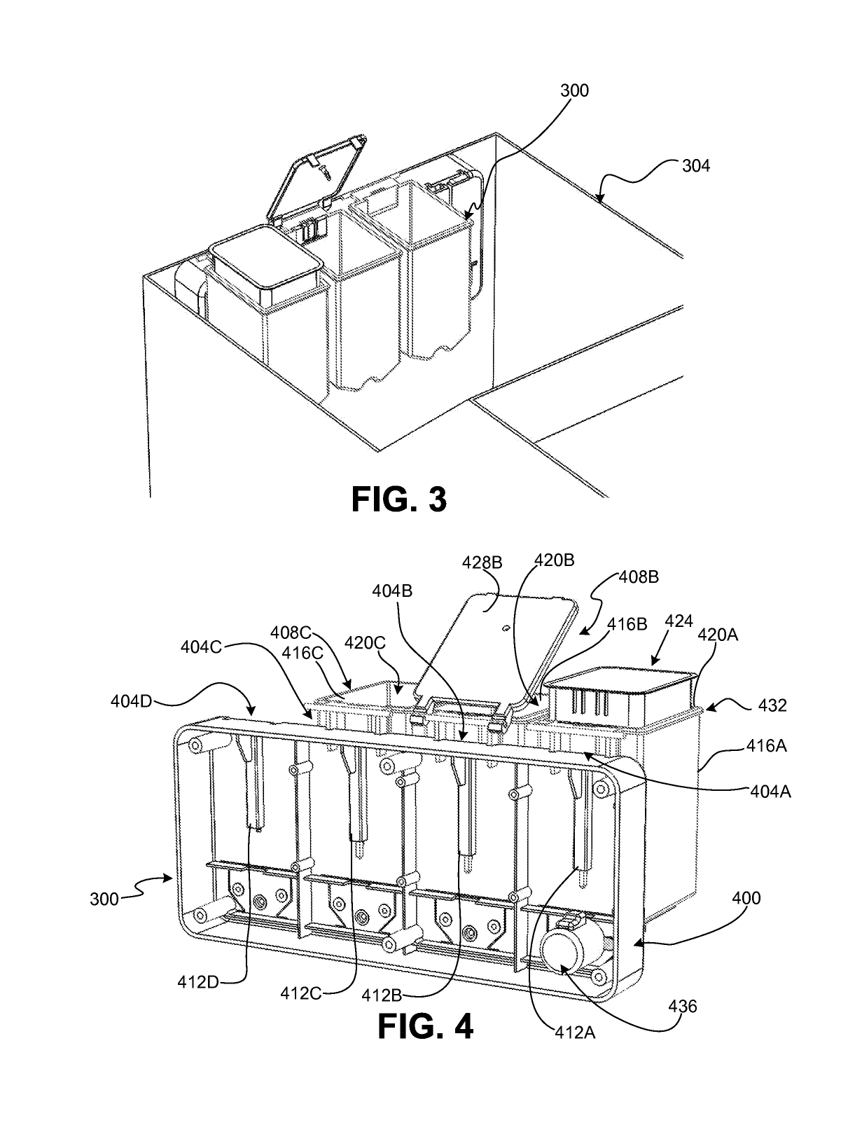

Referring now to FIGS. 3 and 4, these figures illustrate a four-receiver doser 300 having at least some of the features and functionalities described above in connection with multi-receiver doser 204 and doser 120 of FIGS. 2 and 1, respectively, in addition to having additional features and functionalities. In the example shown in FIGS. 3 and 4, doser 300 is designed and configured to be mounted on an aquarium sump assembly 304 (FIG. 3), which as those skilled in the art know is a common component of moderate to high-end aquarium setups (not shown) for both home and commercial installations. While doser 300 is shown engaged with sump assembly 304, skilled artisans will readily appreciate that the doser, as with similar aquarium-targeted dosers made in accordance with the present disclosure, can be mounted to another component of an aquarium setup, such as the tank (not shown) itself or a tank-mounted filter housing, among others.

As better seen in FIG. 4, in this example, doser 300 includes a base 400 having four identical receivers 404A to 404D for removably receiving matingly designed corresponding respective dispensing bins, three of which, i.e., bins 408A to 408C, are illustrated in FIG. 4 as being engaged with receivers 404A to 404C, respectively. In FIG. 4, receiver 404D is empty but is ready to receive a dispensing bin that is like dispensing bins 408A to 408C. In this example, dispensing bins 408A to 408C are engageable with base 400 by vertical sliding engagement of an engagement member (not shown) on each bin that has a T-shaped cross-section in a horizontal plane into a T-shaped vertical track, the backside structures 412A to 412D of which are visible in FIG. 4. Those skilled in the art will readily understand that there are many ways that dispensing bins can be engaged, both removably and permanently, with a base in dosers that are generally similar to doser 300 of FIGS. 3 and 4.

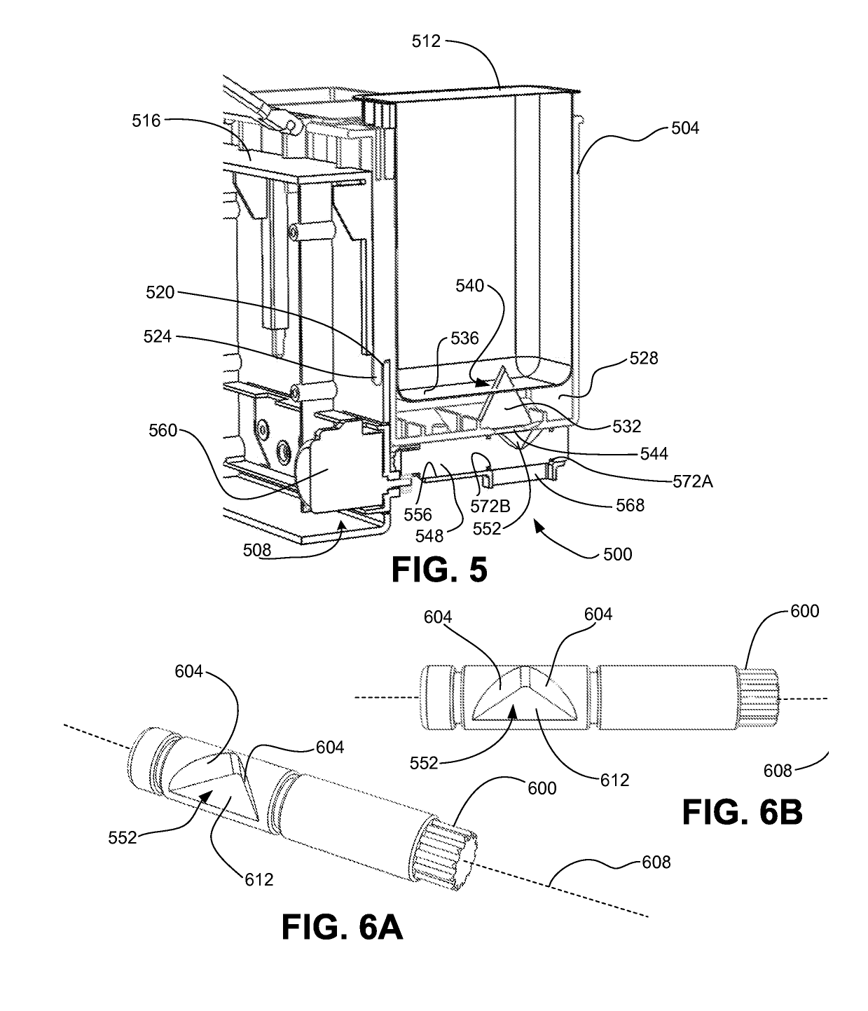

Referring to FIG. 4, each dispensing bin 408A to 408C includes a body 416A to 416C that defines an additive receiver that is a receptacle 420A to 420C for receiving a corresponding additive container, only one of which, i.e., additive container 424, is shown in FIG. 4 (also in FIG. 3). As with additive containers 128 and 208A to 208D of FIGS. 1 and 2, respectively, each additive container suitable for dispensing bins 408A to 408C, such as container 424, can be either a prepackaged container or a user-fillable/refillable container. It is noted that in some embodiments, additive containers, such as container 424, need not be used and the dispensing bins can be filled directly with the proper additives. In this example, each bin includes lid (though only lid 428B is shown), which in the particular instantiation shown is hingedly engaged with the corresponding body 416A and 416B. In other instantiations, the lid provided to each dispensing bin need not be secured to or otherwise coupled with the bin. Each lid 428A and 428B is designed and configured to capture a flange of the corresponding additive container, such as flange 432 of container 424 in the case of bin 408A, between it and the body of the corresponding bin, here body 416A, to form a hermetic or near-hermetic seal for inhibiting moisture from entering the corresponding receptacle (here, receptacle 420A) and from getting into any additive in that receptacle. It is noted that in alternative examples, a bin may not have a corresponding lid. Also seen in FIG. 4 is an electric motor 436 for driving a dispensing mechanism (not shown) that in this example is part of dispensing bin 408A. FIG. 5, described below, illustrates a dispensing mechanism 500 that can be driven by motor 436 or similar driver. It is noted that receivers 404B to 404D may also have corresponding drivers (not shown in FIG. 5).

FIG. 5 illustrates an exemplary arrangement of dispensing mechanism 500 in relation to a dispensing bin 504, a dispensing drive system 508, an additive container 512, and a doser base 516, which in this example is similar to base 400 of doser 300 of FIGS. 3 and 4. Referring to FIG. 5, dispensing bin 504 is removably attached to doser base 516 via a mechanical interlock arrangement 520 and a click-fit lock 524 that locks the bin into place. Additive container 512 is shown partially inserted into a receptacle 528 of dispensing bin 504, which in this example is suitable for use with prepackaged additive containers and correspondingly includes a piercing structure 532 designed, configured, and located to pierce a wall 536 of the additive container as a user inserts the container into receptacle 528. The opening 540 in wall 536 after piercing allows the additive (not shown) within additive container 512 to flow out of the container for dispensing. In the instantiation shown, piercing structure 532 is a puncturing blade, but in other instantiations the piercing structure can be different. In another example, structure 532 can be a side by side twin-tip puncturing blade. Examples of other piercing structures include, but are not limited to tubular structures in which, after puncturing, the additive flows through the tubular structures, other puncturing-knife structures, and slicing-knife structures, among others. Among other materials, a piercing structure of the present disclosure can be made of zirconia, which is extremely hard and corrosion resistant. The last example just given can be used, for example, for slicing sidewalls of additive containers in embodiments in which the additive containers are installed vertically into doser receptacles and for slicing bottom walls of additive containers in embodiments in which the additive containers are installed horizontally into doser receptacles.

In the instantiation shown, dispensing bin 504 includes an opening 544 that allows the additive from additive container 512 to flow to dispensing mechanism 500, which here includes a rotary dispensing rod 548 having a dispensing receptacle 552 that periodically receives the additive as the dispensing rod is rotated during dispensing operations. In the instantiation shown, dispensing rod 548 is rotatable within a cylindrical receiver 556 formed within dispensing bin 504 and is rotated by drive system 508, which in this example includes an electric motor 560 that interfaces with external teeth 600 (FIGS. 6A and 6B) of the rod. Dispensing bin 504, in this instantiation, includes a dispensing outlet 568 in registration with opening 544 of the bin and dispensing receptacle 552 of dispensing rod 548. As those skilled in the art will readily appreciate, dispensing receptacle 552 is configured so that, depending on the rotational position, dispensing rod 548 can completely block the flow of additive from opening 544 to dispensing outlet 568. To effect a complete seal against additive from within dispensing bin 504 flowing out of the bin, a pair of gaskets 572A and 572B are located on either side of dispensing receptacle 552. As seen in FIG. 6, dispensing rod 548 includes a pair of grooves 604A and 604B that receive corresponding respective ones of gaskets 572A and 572B. It is noted that in examples when gaskets 572A and 572B (FIG. 5) form a liquid-tight seal, dispensing bin 504 and dispensing mechanism 500 can be used with both liquid and dry-flowable additives, at the desire of the user. Due to this versatility, a user generally never needs to be concerned about the form of additives used, making the system universal for these forms of additives.

Still referring to FIGS. 6A and 6B, this figure illustrates the particular configuration of dispensing receptacle 552 of this exemplary dispensing rod 548. As noted above, dispensing system 500 (FIG. 5) is intended to be used with both liquid and dry-flowable additives. The present inventor has found that with certain dry-flowable additives, the shape of the radially outer trailing edge 604 of dispensing receptacle 552 and/or the shape of the trailing edge of opening 544 can be important. This is so because certain additives, e.g., crystalline additives, can result in relatively large resistance to rotation of dispensing rod 548 when edges 604 and the trailing edge of opening 544 are parallel to one another and the difficult-to-shear particles get trapped between the parallel edges. However, when edges 604 and trailing edge of opening 544 are skewed relative to one another, the shearing resistance is lessened because at any point in time as edge 604 is moving past the trailing edge of opening 544, there is only a relatively small region where shearing is occurring, as opposed to the entire length of the (shorter of the) two edges when the edges are parallel to one another. As seen in FIGS. 6A and 6B, trailing edge 604 is made to form a V-shape. Correspondingly, trailing edge (FIG. 5) of opening 544 is made in a shape other than a matching V-shape, such as a linear shape or a V-shape that is in an opposite direction from the V-shape of trailing edge 604, among others. Regarding the latter example, the two V-shapes could be arranged so that just before dispensing rod 548 is rotated to close opening 544, the two apexes of the V-shapes are immediately adjacent to one another. Those skilled in the art will understand that other shapes are possible, including linear shapes that are not parallel to one another.

With dispensing mechanism 500 and like dispensing mechanisms made in accordance with aspects of the present invention, in one example dosing of an aquatic environment can proceed as follows. In this example, dispensing receptacle 552 has a precisely known volume 612 (FIG. 6) that is no larger than the smallest amount of additive that dispensing mechanism 500 is desired for use with. In this manner, the dosage will never be larger than needed. In addition, with volume 612 being no larger than the minimum dosage, dosages larger than the volume can be achieved by simply rotating dispensing rod 548 as many times as needed, with the total amount of additive dosed being equal to the number of revolutions of dispensing receptacle 552 multiplied by volume 612. As those skilled in the art will readily appreciate, volume 612 can be determined as a function of, among other things, information about the additives that can be used for a particular aquatic environment, the amount of water in the aquatic environment, the minimum tolerance of the aquatic environment to overdosage of the most critical additive by a fraction of the volume of dispensing receptacle 552 if the amount of additive in the last dispensing revolution of dispensing rod 548 is more than needed, and the offset between a desired water-constituent level and a measured level at which a decision is made to dose a particular additive. In other embodiments, the amount of additive being dispensed by a dispensing mechanism of the present disclosure can be determined in another manner, such as by weight or volume measured in a manner other than via a precision-volume dispensing receptacle, for example, by sensing the level of the additive within the additive container, sensing the weight of the additive dispensed, using a flow meter, etc.

FIG. 17 illustrates another example of a dispensing rod 1700 that may be used in a dispensing mechanism of a dosing system according to the present disclosure (such as dosing system 100, dosing system 500, etc.). Dispensing rod 1700 includes tapered sides 1702 that taper from a wide portion to a narrower portion at the tip. Similar to dispensing rod 548 shown in FIGS. 6A and 6B, dispensing rod 1700 also includes a dispensing receptacle 1752. In this example, edges 1704 of dispensing receptacle 1752 are shown shaped similarly to the edges of rod 548. It is noted that a dispensing rod that has tapered sides may have any of a variety of configurations and any of a variety of shaped and configured dispensing receptacles. In one exemplary aspect, a tapered dispensing rod may provide a benefit of a conformal fit with a tapered dispensing rod receiver (e.g., as part of a dispensing bin). Such a conformal fit may provide for a better seal between a dispensing rod and a dispensing rod receiver.

Referring again to FIG. 5, it is noted that while this figure shows a separate dispensing bin 504 and additive container 512, in other embodiments the dispensing bin can be eliminated and dispensing mechanism 500 integrated into an additive container directly. For example, such an additive container with an integrated dispensing mechanism can be sold as a prepackaged assembly that can also be disposable. As an example and using FIG. 5 for illustration, in such dispensing mechanism-enhanced additive containers, one can envision dispensing bin 504 being the additive container and filled directly with an additive. Then, instead of the lid of dispensing bin 504, the enhanced additive container could be sealed with a suitable closure, for example, foil, plastic, paper, etc. This would eliminate the need for piercing structure 532. For shipping and stocking purposes, dispensing outlet 568 could be provided with a removable seal (not shown) of foil, plastic, paper, etc., that a user would remove before installing onto doser base 516. The interface between the dosing mechanism of such an enhanced container (which could be the same as or similar to dosing mechanism 500) with reduction gear 564 can be the same as illustrated in FIG. 5.

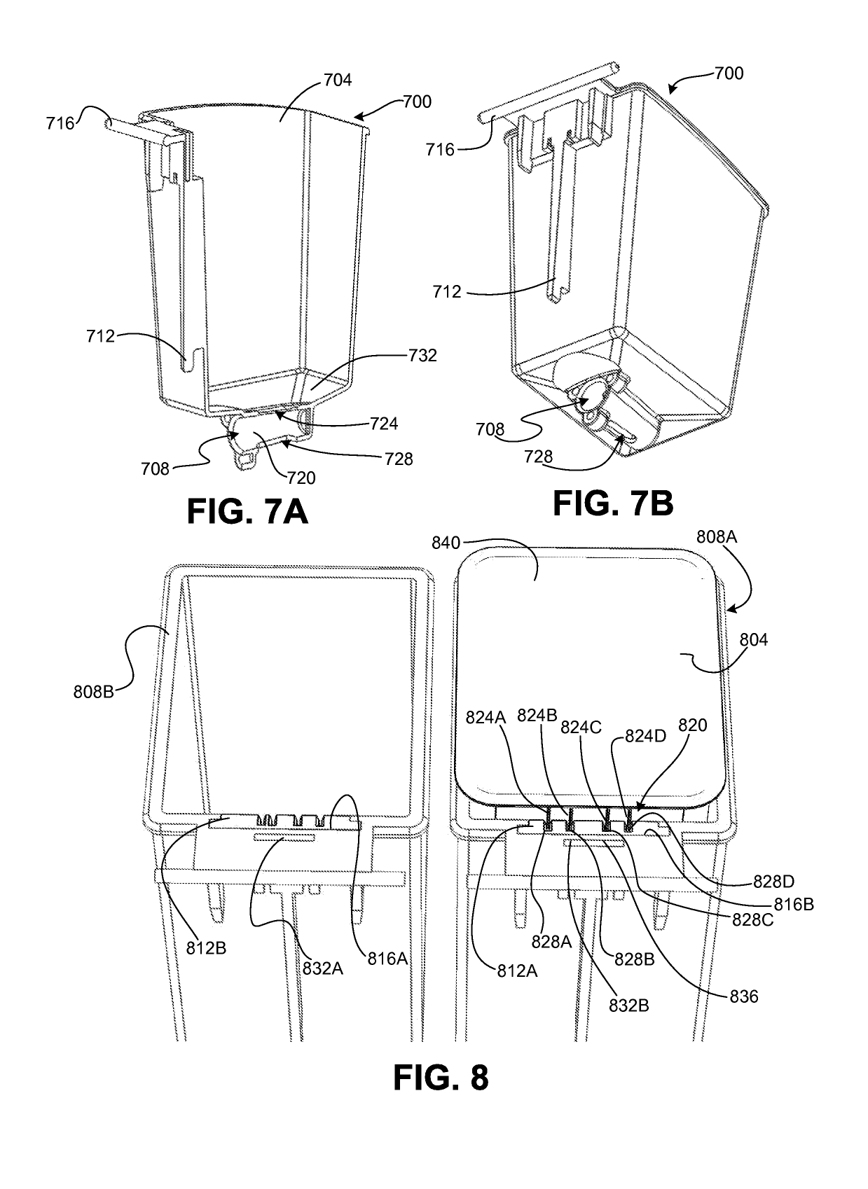

FIGS. 7A and 7B illustrates a dispensing bin 700 that is usable with certain dosing apparatus made in accordance with aspects of the present invention, such as doser 120 of FIG. 1, doser 200 of FIG. 2, and doser base 516 of FIGS. 3-5. In this example, dispensing bin 700 includes an additive receiver that is a receptacle 704, a dispensing-rod housing 708, a bracket 712, and a hinge pin 716. Receptacle 704 is designed and configured to receive an additive container (not shown), such as in any of the manners described above. Dispensing-rod housing 708 is designed and configured to receive a dispensing rod (not shown) that can be similar to dispensing rod 548 of FIGS. 5 and 6A/6B and FIG. 17. In the present example, dispensing-rod housing 708 has a tapered interior wall 720 designed and configured to conformally receive a like-tapered dispensing rod. Hinge pin 716 is designed and configured to hingedly receive a lid (not shown) for sealing additive receptacle 704 and allowing a user to insert and remove additive containers as they are needed. Similar to dispensing bin 504 of FIG. 5, dispensing bin 700 of FIGS. 7A and 7B includes an opening 724 at the bottom of receptacle 704 and a dispensing outlet 728 in registration with opening 724 to allow a dispensing receptacle (not shown) of a dispensing rod to convey an additive from proximate the opening to the dispensing outlet as the dispensing rod is turned. In this embodiment, receptacle 704 includes a sloped bottom 732 that slopes to opening 724 to assist in the flow of an additive within the receptacle.

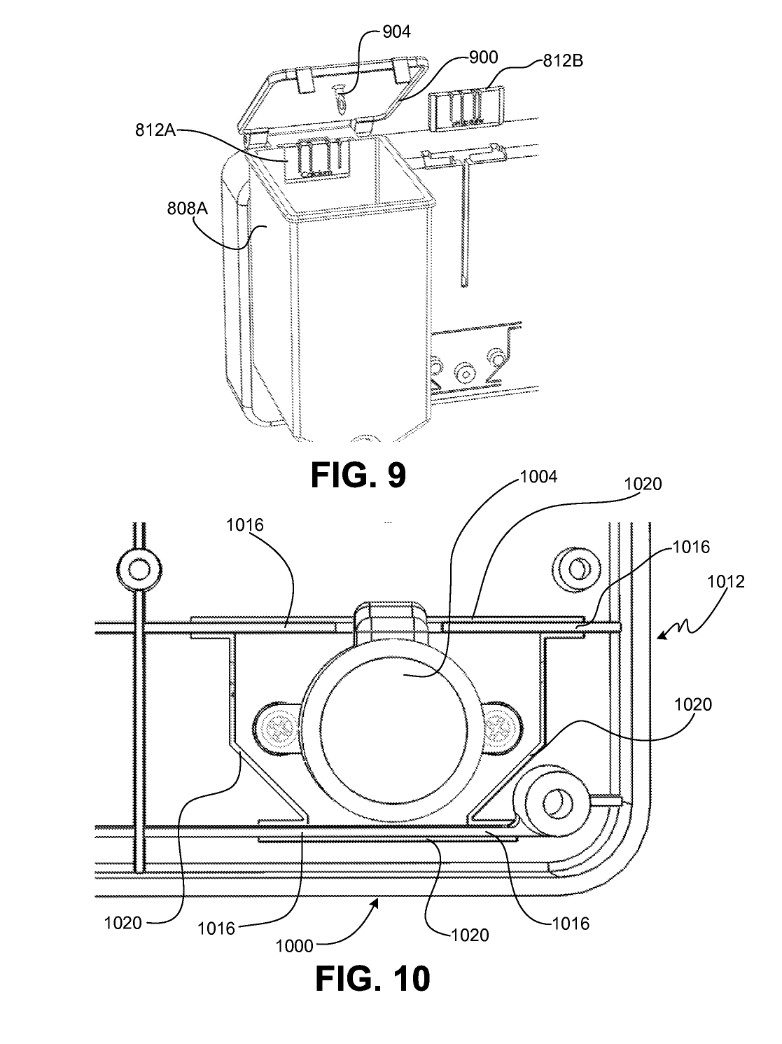

FIGS. 8 and 9 illustrate an exemplary keying system 800 that can be used to ensure that a user inserts a proper additive container, such as container 804 of FIG. 8, into an appropriate dispensing bin or receiver, such as either of dispensing bins 808A and 808B. In this example, keying system 800 includes slotted inserts 812A and 812B that are user-engageable with insert receivers of dispensing bins usable with the keying system, here insert receivers 816A and 816B of bins 808A and 808B, respectively. It should be understood that slotted inserts 812A and 812B, which each have a slot pattern that corresponds uniquely to a corresponding type of additive, allow a generic dispensing bin, such as either one of dispensing bins 808A and 808B, to be “customized” to receive only one type of additive. In the present example, slotted insert 812A is for a calcium additive and slotted insert 812B is for a pH-increasing-buffer additive. In other embodiments, the additive may be any other additive needed for a particular aquatic environment.

Each additive container for a particular slotted insert in such an embodiment would have a key structure that mates with the slotted insert when the container is properly installed into the dispenser bin. This is illustrated in FIGS. 8 and 9, in which additive container 804 has a key structure 820 comprising a plurality of fins 824A to 824D that engage a corresponding respective plurality of slots 828A to 828D of slotted insert 812A. Note that slotted insert 812B has a differing spacing for slots 828A to 828D that would prevent a user from inserting additive container 804 into dispensing bin 808B because the spacing of fins 824A to 824D on additive container 804 does not match the spacing of the slots on slotted insert 812B. One can readily envision the multitude of slot and fin arrangements that can be implemented to ensure that the proper additive is inserted into the proper dispensing bin. It is noted that the interengaging structures need not be slots and fins, but may be virtually any structures that can engage one another when they match and that can interfere with one another when there is not a match between the additive and the dispensing bin. In addition, it is noted that the keying structures of a keying system of the present disclosure need not be only on one side of each of the additive container and dispensing bin and need not be on the sides of the additive container and dispensing bin at all. Regarding the former, if the additive container is a multisided (e.g., not a cylindrical shape, not a frusto-conical shape, or not another shape that may not be considered to have multiple sides), the keying structures can be on any two or more, including all sides. Regarding the latter, the mating/interfering structures can be located, for example, on the bottoms of an additive container and, correspondingly, on the bottom of a dispensing bin, on one or more flange(s) of an additive container and, correspondingly, on a rim of a dispensing bin, etc. Those skilled in the art will be able to devise many keying systems that fall within the scope and spirit of the present invention. Further, it is noted that if a dispensing bin has a piercing structure, such as piercing structure 532 of FIG. 5, if there is an interference between the keying structures of a keying system, as there would be if additive container 804 of FIG. 8 were attempted to be inserted into dispensing bin 808B, that interference could prevent the user from pushing the additive container to the point where the piercing structure would pierce the container. This would keep an incorrect additive from contaminating a dispensing bin intended for a different additive.

In the embodiment shown in FIG. 8, each of dispensing bins 808A and 808B includes an identification (ID) device receiver 832A and 832B that receives a corresponding ID device (shown inserted therein), such as an RFID device or a magnetic storage device, among others. Each ID device in a receiver 832A and 832B would be matched to the corresponding slotted insert 812A and 812B in that it would be programmed with information identifying the additive to the system controlling dosing. Correspondingly, the overall dosing system (not shown) could include a reader, such as an RFID or magnetic reader, for reading ID devices.

FIG. 9 shows slotted inserts 812A and 812B from a different perspective and shows dispensing bin 808A being present and dispensing bin 808B (FIG. 8) not being present, with slotted insert 812B shown hovering at a location above where it would be if it were installed in bin 808B and bin 808B were in its installed location. FIG. 9 also illustrates dispensing bin 808A as having a lid 900 hingedly attached to the rest of the bin. Lid 900 in this embodiment includes a piercing vent 904 for the purpose of piercing an upper end of an additive container, such as the upper end 840 additive container 804 of FIG. 8. Piercing vent 904 (FIG. 9) allows air to flow from outside of dispensing bin 808A to prevent a negative pressure (relative to ambient pressure) from forming inside the additive container as the additive is dispensed. As those skilled in the art will readily appreciate, a negative pressure can interfere with proper dispensing. As some examples, upper end 840 of additive container 804 can be a foil closure, a paper closure, a plastic closure, an upper wall, etc.

FIG. 10 illustrates an exemplary suspended support 1000 for mounting a drive motor 1004 (which can be a stepper motor) to a doser base 1012 to permit measuring of the weight of the additive present in an additive container. As those skilled in the art will appreciate that suspended support 1000 can be used to modify doser base 516 of FIG. 5 to give that doser base a weighing functionality. Referring to FIG. 10, suspended support 1000 includes strategically configured structural members 1016 and discontinuities 1020 in base 1012 that form a dispensing-mechanism support 1024 that can move in a meaningful and controlled manner under the influence of the weight of a dispensing bin, additive container, and an additive bearing down on the other side of reduction gear 1008 in the manner of dispensing rod 548 bearing on reduction gear 564 in FIG. 5. The attachment arrangement (not shown) of the dispensing bin to doser base 1012 can be configured to allow for relatively frictionless vertical movement of the dispensing bin so that the deflection of dispensing-mechanism support 1024 correlates well to the weight of the dispensing bin, additive container, and additive. This way, by measuring the changes in deflection of dispensing-mechanism support 1024, for example, using one or more appropriately located strain gages (not shown), as the additive is dispensed, the amount of additive dispensed can be determined. Such a measurement can be used for any one or more of a variety of reasons, such as to check whether the dispensing mechanism is working properly (e.g., not clogged) and to determine if the correct dosage of additive has been applied. In another example, a weight measurement can be used to determine if an additive container is present in a receiver of a bin of a doser.

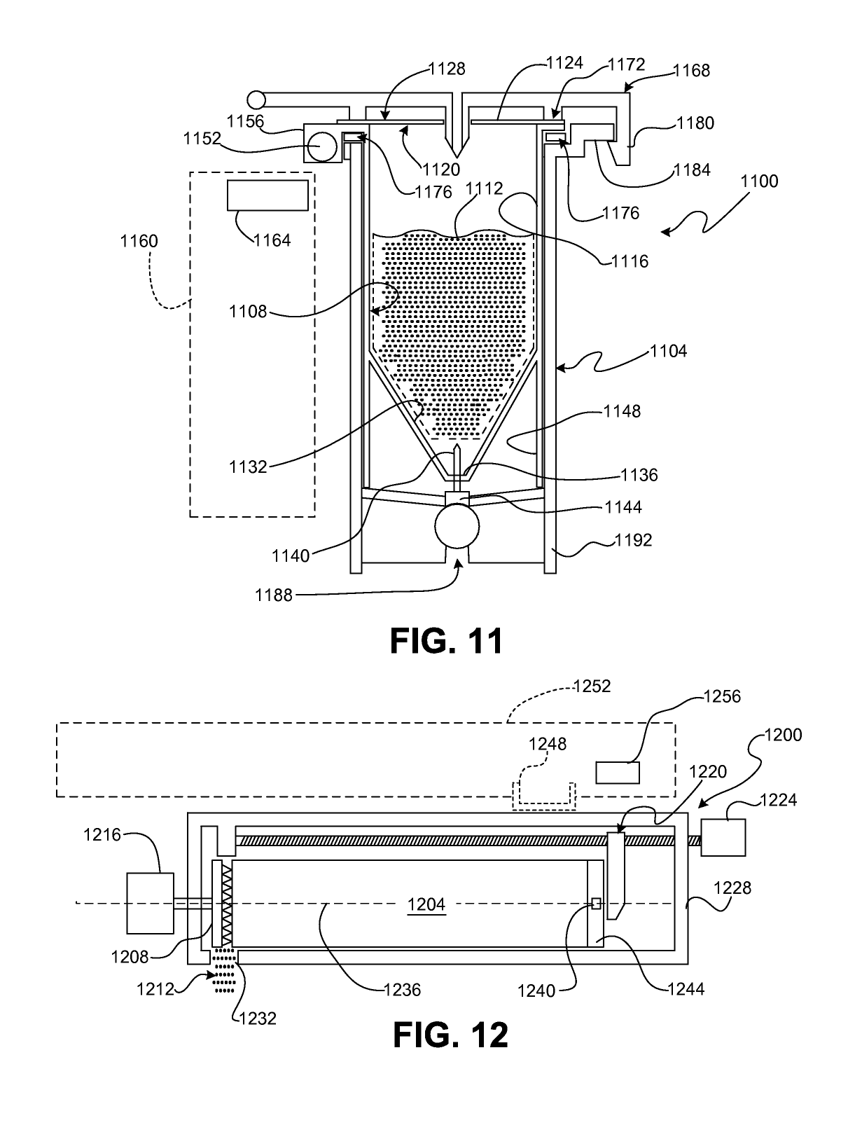

FIG. 11 illustrates another example of a dispensing bin/additive container arrangement 1100 that can be used with an intelligent dosing system, such a dosing system of the present disclosure. In this example, arrangement 1100 includes a dispensing bin 1104 and an additive container 1108, which is shown fully engaged with the dispensing bin. Additive container 1108 is a prepackaged additive container that contains an additive 1112 and comprises a thin-walled cup 1116 having an upper opening 1120 sealed by a suitable closure 1124, such as a foil closure, that is bonded to an upper end 1128 of the cup. Cup 1116 in this example has a sloped bottom 1132 that forces additive 1112 to flow to a central region 1136 at the bottom of the cup, where the cup is pierced by a piercing member 1140 during insertion of additive container 1108 into dispensing bin 1104 to allow the additive to flow into the bottom of the dispensing bin for dispensing, here through opening 1144. In the example shown, additive container 1108 includes an integral stand structure 1148 that allows a user to stand the additive container vertically for convenient and orderly storage. In the example shown, stand structure 1148 is a continuous skirt. However, in other embodiments stand structure 1148 can take different forms, such as spaced legs, among others.

Additive container 1108 includes an additive-identification device 1152, which in the example shown is an RFID device. In other embodiments, additive-identification device 1152 can be of another type, such as a magnetic device or an optically readable device, among others. In this example, additive container 1108 includes a tab 1156 that holds additive-identification device 1152. In other embodiments, additive-identification device 1152 can be located elsewhere on additive container 1108. Correspondingly, the doser to which dispensing bin 1104 is secured, here doser 1160, includes a reader 1164 designed and configured to read the type of additive-identification device 1152 used on additive container 1108. In the case of additive-identification device 1152 being an RFID device, reader 1164 would be an RFID-device reader. If the additive-identification device used as additive-identification device 1152 is also a writable device, reader 1164 can include writing capabilities.

Dispensing bin 1104 includes a hinged lid 1168 that hermetically seals the upper end of the dispensing bin by compressing portions, such as flange 1172, of additive container 1108 against a compressible gasket 1176 as shown. Lid 1168 includes a latch 1180 that latches with a catch 1184 formed on dispensing bin 1104. Other lid-securing means can be used in place of the latch/catch arrangement shown. In this example, dispensing bin 1104 is removable from doser 1160. A reason for making dispensing bin 1104 removable, in this case along with a dispensing mechanism 1188 that is integral with the bin, is to make it easy for a user to switch additives even when one of the additives is only partially used. When an additive container has already been installed in a dispensing bin but the additive has only been partially used, it is difficult to remove just the additive container because of the hole created by the piercing member. Consequently, it is desirable to keep the additive container in the dispensing bin and swap out the entire dispensing bin/additive container arrangement, here arrangement 1100. In this example, to facilitate storage of dispensing bin/additive container arrangement 1100, dispensing bin 1104 includes a stand structure 1192, which in this example comprises a skirt extending around the perimeter of the bin. An additive container may include a stand structure of any type or no stand structure. In other embodiments, stand structure 1192 may be different, such as a set of spaced legs.

FIG. 12 illustrates an exemplary dispenser 1200 that can be used with an intelligent dosing system, such as any one of the intelligent dosing systems described in this disclosure. Dispenser 1200 is designed and configured for dispensing additives that are engaged with the dispenser as a unitary mass, such a unitary mass 1204. Such unitary masses can be formed, for example, by compressing other forms of additives, such as powders, etc. In this example, dispenser 1200 includes a discretizer 1208, such as a grinder, rotary or grater, shaver, etc., for creating discretized particles 1212 suitable for dispensing into the aquatic environment (not shown). Discretizer 1208 can be rotary, linear, orbital, etc., or any combination thereof. In the embodiment shown discretizer 1208 is a rotary grinder driven by a suitable electrical motor 1216.

In some embodiments, unitary mass 1204 can be advanced into discretizer 1208 via gravity feed. However, in other embodiments, dispenser 1200 can optionally include an advancing mechanism 1220, which in this example advances unitary mass 1204 into discretizer 1208 during discretizing and dispensing operations. Advancing mechanism 1220 can be any suitable mechanism, such as a screw mechanism, hydraulic mechanism, pneumatic mechanism, spring mechanism, magnetic mechanism, etc., or any combination thereof, which can be driven by any suitable actuator(s) 1224. Unitary mass 1204 can be contained in a suitable housing 1228, which can include a dispensing outlet 1232 for dispensing discretized particles into the aquatic environment. It is noted that the present example shows dispenser 1200 having the advancement axis 1236 oriented horizontally, but in other embodiments the advancement axis can be oriented otherwise, such as vertically, with suitable changes, such as, for example, a change in location of dispensing outlet 1232 and motor 1216.

Corresponding to additive-identification device 1240, the doser with which dispenser 1200 is associated, here doser 1252, includes a reader 1256 designed and configured to read the type of the additive-identification device provided with unitary mass 1204. In the case of additive-identification device 1240 being an RFID device, reader 1256 would be an RFID-device reader. If the additive-identification device used as additive-identification device 1240 is also a writable device, reader 1256 can include writing capabilities.

In this example, unitary mass 1204 is purchased with a corresponding additive-identification device 1240, which can be any of the additive-identification devices described above. However, for convenience, additive-identification device 1240 can be the same as any one of the additive-identification devices described above. In the example shown, additive-identification device 1240 is embedded in an end cap 1244 that is attached to unitary mass 1204. In other embodiments, additive-identification device 1240 can be provided in another manner, such as separate from unitary mass 1240, in which case the device can be suitably engaged with dispenser 1200, such as in an identification-device receptacle 1248.

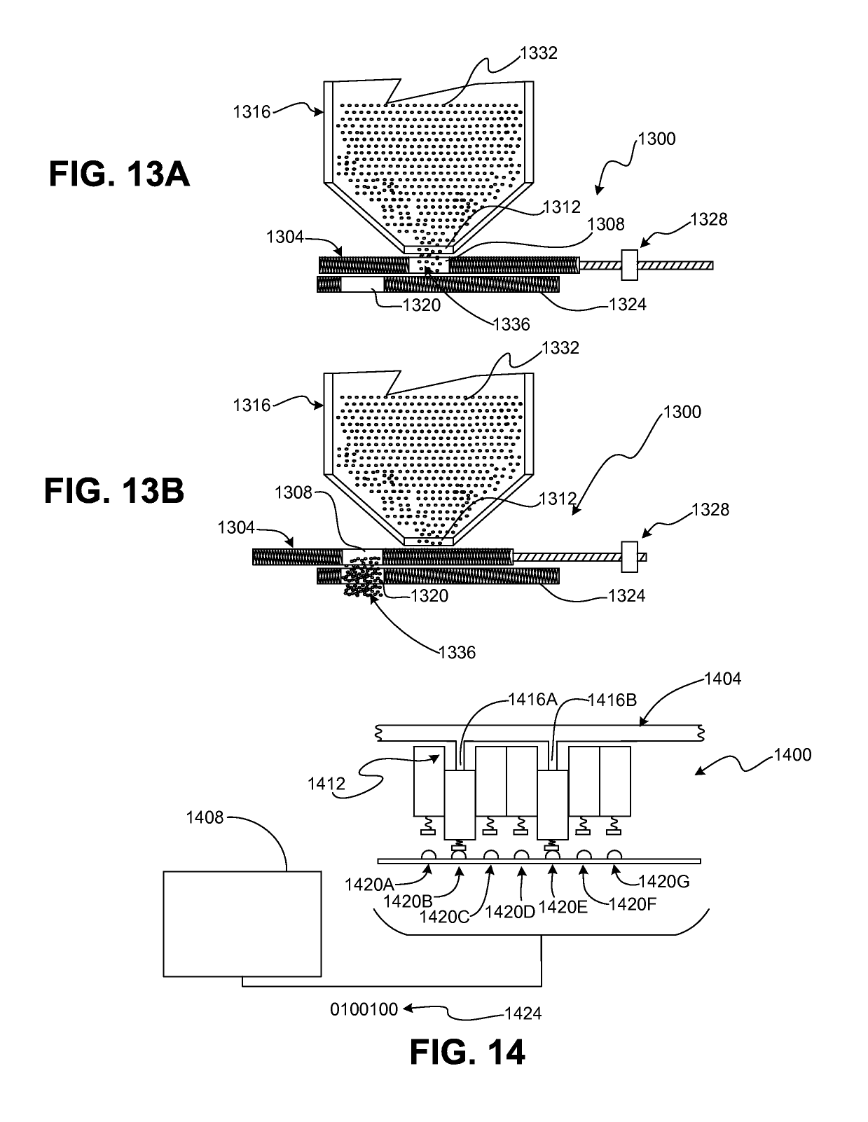

FIGS. 13A and 13B illustrate an exemplary linear dispensing mechanism 1300 that can be used with a dosing system, such as a dosing system of the present disclosure. Dispensing mechanism 1300 includes a reciprocating bar 1304 having a dispensing receptacle 1308 that is alternatingly positionable at an outlet 1312 of a container 1316, which can be either a dispensing bin or an additive container, and a dispensing outlet 1320 of a slide structure 1324 along which the reciprocating bar slides. Reciprocating bar 1304 can be reciprocatingly driven by any suitable actuating mechanism 1328, such as a screw mechanism (shown), hydraulic mechanism, pneumatic mechanism, spring mechanism, magnetic mechanism, etc., or any combination thereof. In FIG. 13A, dispensing receptacle 1308 is positioned in registration with outlet 1312 of container 1316 where it is filled with an additive 1332 from the container. To dispense the portion 1336 of additive 1332 in dispensing receptacle 1308, actuating mechanism 1328 pushes bar 1304 so that dispensing receptacle 1308 is in registration with dispensing outlet 1320 (as seen in FIG. 13B), where portion 1336 of additive 1332 falls through the dispensing outlet and into the aquatic environment. Actuating mechanism 1320 can then retract dispensing receptacle 1308 back into registration with outlet 1312 of container 1316 for refilling and another dispensing.

All aspects of dosing an additive, such as additive 1332, with reciprocating bar 1304 can be the same as for dispensing rod 548 described above with respect to FIG. 5, except the type of movement the dispensing bar experiences relative to dispensing rod 548 of FIG. 5. For example, the volume of dispensing receptacle 1308 of FIGS. 13A and 13B can be determined in the same manner as dispensing receptacle 552 of FIG. 5, as well as the orientations of the leading and trailing edges of outlet 1312 and dispensing receptacle 1308 to avoid needing to create high shearing forces at parallel edges for certain types of additives.

FIG. 14 illustrates an exemplary electrical-switch-based additive-identification system 1400 that can be used with additive containers, such as additive container 1404, to identify to an intelligent dosing system, such as dosing system 1408, which type of additive (not shown) is in a particular additive container. Additive-identification system 1400 includes an additive-identification device 1412, here two projections 1416A and 1416B formed on additive container 1404, that interact with one or more electrical switches, here, switches 1420A to 1420G to create an identification signal or signal set 1424 that is uniquely keyed to the additive in the container. For example, projections 1416A and 1416B close switches 1420B and 1420E, but leave switches 1420A, 1420C, 1420D, 1420F, and 1420G open, which can be considered to create a signal pattern 1424 of 0100100, with “0” designating an open switch and “1” designating a closed switch. The manufacturer of additive container 1404 can be instructed to use two switch-activating projections (e.g., projections 1416A and 1416B) in the locations shown only for containers containing calcium as an additive. Correspondingly, dosing system 1408 can be programmed to recognize signal pattern 1424 of 0100100 to indicate that calcium is present in the container interacting with switches 1420A to 1420G. As an example of use of identification system 1400, one can envision slotted inserts 812A and 812B of FIG. 8 each being replaced by sets of switches, like switches 1420A to 1420G, and fins 824A to 824D interacting with ones of such switches. In other embodiments, a set of switches and corresponding projections can be located at a location other than a side of an additive container, such as at the bottom of an additive container or along an upper flange of an additive container, among others. It is also noted that the number of switches may be different from the seven switches 1420A to 1420G shown in the present example. Further, instead of the switches being configured to interact with one or more projections on an additive container as shown, the switches can be configured to interact with one or more recesses present on an additive container. Those skilled in the art will recognize the various ways that an electrical-switch-based identification system of the present disclosure can be configured within the spirit and scope of this disclosure.

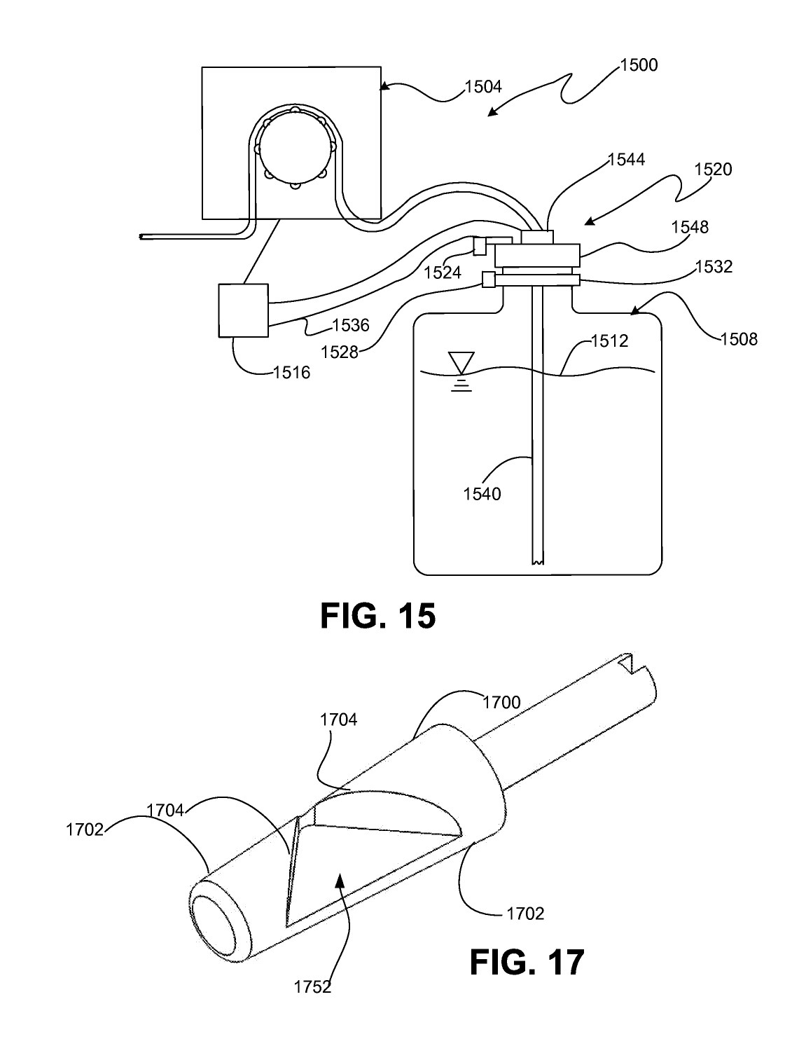

In some circumstances, conventional dispensing apparatuses, such as peristaltic pumps, can be adapted for use with an intelligent dosing system, such as an intelligent dosing system of the present disclosure. FIG. 15 illustrates a peristaltic pump setup 1500 that includes a conventional peristaltic pump 1504 and an additive container 1508 containing a liquid additive 1512 for dispensing to an aquatic environment (not shown) by the peristaltic pump. To adapt pump 1504 and additive container 1508 to an intelligent dosing system, such as intelligent dosing system 1516, peristaltic pump setup 1500 includes a “smart cap” 1520 that integrates with the intelligent dosing system. Smart cap 1520 of this example includes a reader 1524 for reading an additive-identification device 1528 that is secured to additive container 1508. As with other readers and additive-identification devices, reader 1524 and device 1528 can be of any suitable type, such as RF, magnetic, optical, haptic (e.g., switch-based like set of switches 1420A to 1420G of FIG. 14), etc. Additive-identification device 1528 can be secured to additive container 1508 in any suitable manner, such as on a support ring 1532 as shown in FIG. 15. Reader 1524 is in communication with intelligent dosing system 1516 via any suitable communications link, here, a wired link 1536. In other embodiments, the communications link can be wireless. In this example, when smart cap 1520 is engaged with additive container 1508, reader 1524 reads additive-identification device 1528 and notifies intelligent dosing system 1516 so that the dosing system knows about additive 1512 and can control peristaltic pump 1504 properly according to calculated dosing requirements. Reader 1524 can also include the ability to write to additive-identification device 1528 depending on the nature of the additive-identification device and its use.

In this example, because smart cap 1520 is designed for use with peristaltic pumps, here, peristaltic pump 1504, which are known to back-feed additive in the drawtube 1540 back into additive container 1508 when the pump is not running, the smart cap includes a back-feed sensor 1544 that is designed and configured to sense the amount of back-feeding that occurs in the drawtube. Information from back-feed sensor 1544 is provided to intelligent dosing system 1516, which can be programmed to use this information to adjust the amount of time that peristaltic pump 1504 is run for any given dosing. For example, if a dosing amount is known and it is also known that, with no back-feeding having occurred, peristaltic pump 1504 must be run for a base time, T_{Base}, then dosing system 1516 can use back-feed information from back-feed sensor 1544 to determine an additional amount of time, T_{Add}, to run the pump to counteract the back-feed that occurred since the pump was last run. As with reader 1524, information from back-feed sensor 1544 can be provided to intelligent dosing system 1516 either wirelessly or in a wired manner. Smart cap 1520 may comprise a body 1548 that each of reader 1524, back-feed sensor 1544, and drawtube 1544 may be engaged, by securing, coupling, or other means.

It is noted that smart cap 1520 may also include a liquid level sensor (not shown), such as a sonic sensor present on the underside of body 1548 or a pressure-activated resistive submergible sensor that runs along drawtube 1540.

It is to be noted that the aspects and embodiments described herein may be conveniently implemented using one or more machines (e.g., one or more computing devices/computer systems that are part of an intelligent dosing system or component thereof) that include hardware and special programming according to the teachings of the present specification, as will be apparent to those of ordinary skill in the computer arts. Appropriate software coding can readily be prepared by skilled programmers based on the teachings of the present disclosure, as will be apparent to those of ordinary skill in the software arts.

Such software may be a computer program product that employs a machine-readable storage medium. A machine-readable storage medium may be any hardware medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an 5PROM, and any combinations thereof. A machine-readable storage medium, as used herein, is intended to include a single medium as well as a collection of physically separate media, such as, for example, a collection of compact disks or one or more hard disk drives in combination with a computer memory. As used herein, a machine-readable storage medium does not include a signal.

Such software may also include information (e.g., data) carried as a data signal on a data carrier, such as a carrier wave. Such a data signal or carrier wave would not be considered a machine-readable storage medium. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., tablet computer, a personal digital assistant “PDA”, a mobile telephone (smartphone), etc.), a web appliance, a network router, a network switch, a network bridge, any machine capable of executing a sequence of instructions that specify an action to be taken by that machine, and any combinations thereof.

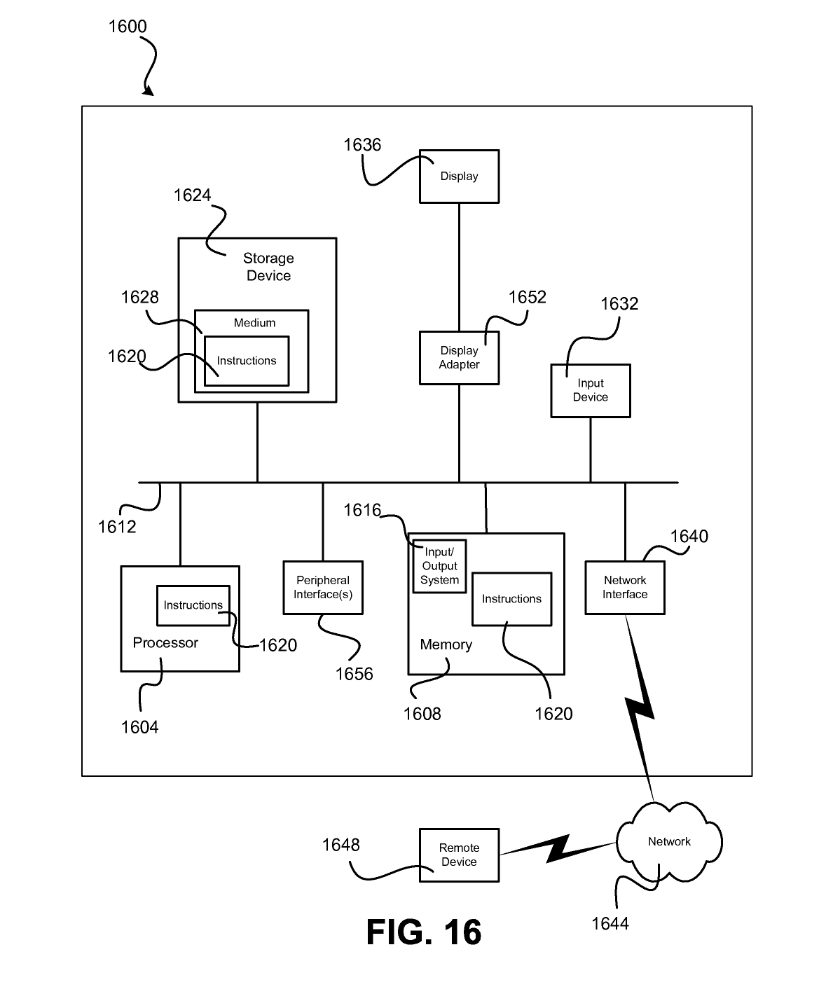

FIG. 16 shows a diagrammatic representation of one exemplary embodiment of a computing system 1600, within which a set of instructions for causing one or more processors 1604 to perform any one or more of the functionalities, aspects, and/or methodologies of the present disclosure so as to create a specific machine, such as a dosing calculator, dosing system controller, intelligent dosing system, etc. For example, a dosing system may include one or more processors (e.g., distributed across one or more components of the dosing system) to process signals related to dosing of an additive, identification of an additive, presence (e.g., via weight) of an additive, etc. (e.g., according to embodiments and implementations discussed above. It is also contemplated that multiple computing systems may be utilized to implement a specially configured set of instructions for performing any one or more of the functionalities, aspects, and/or methodologies of the present disclosure in a distributed computing matter so as to create a specific machine or system of machines.

Computing system 1600 can also include a memory 1608 that communicates with the one or more processors 1604, and with other components, for example, via a bus 1612. Bus 1612 may include any of several types of bus structures including, but not limited to, a memory bus, a memory controller, a peripheral bus, a local bus, and any combinations thereof, using any of a variety of bus architectures.

Memory 1608 may include various components (e.g., machine-readable hardware storage media) including, but not limited to, a random access memory component (e.g., a static RAM “SRAM”, a dynamic RAM “DRAM”, etc.), a read only component, and any combinations thereof. In one example, a basic input/output system 1616 (BIOS), including basic routines that help to transfer information between elements within computing system 1600, such as during start-up, may be stored in memory 1608. Memory 1608 may also include (e.g., stored on one or more machine-readable hardware storage media) instructions (e.g., software) 1620 embodying any one or more of the aspects and/or methodologies of the present disclosure. In another example, memory 1608 may further include any number of program modules including, but not limited to, an operating system, one or more application programs, other program modules, program data, and any combinations thereof.

Computing system 1600 may also include a storage device 1624, such as, but not limited to, the machine readable hardware storage medium described above. Storage device 1624 may be connected to bus 1612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1624 (or one or more components thereof) may be removably interfaced with computing system 1600 (e.g., via an external port connector (not shown)). Particularly, storage device 1624 and an associated machine-readable medium 1628 may provide nonvolatile and/or volatile storage of machine-readable instructions, data structures, program modules, and/or other data for computing system 1600. In one example, software instructions 1620 may reside, completely or partially, within machine-readable hardware storage medium 1628. In another example, software instructions 1620 may reside, completely or partially, within processors 1604.

Computing system 1600 may also include an input device 1632. In one example, a user of computing system 1600 may enter commands and/or other information into computing system 1600 via one or more input devices 1632. Examples of an input device 1632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touch screen, and any combinations thereof. Input device(s) 1632 may be interfaced to bus 1612 via any of a variety of interfaces (not shown) including, but not limited to, a serial interface, a parallel interface, a game port, a USB interface, a FIREWIRE interface, a direct interface to bus 1612, and any combinations thereof. Input device(s) 1632 may include a touch screen interface that may be a part of or separate from display(s) 1636, discussed further below. Input device(s) 1632 may be utilized as a user selection device for selecting one or more graphical representations in a graphical interface as described above.

A user may also input commands and/or other information to computing system 1600 via storage device 1624 (e.g., a removable disk drive, a flash drive, etc.) and/or network interface device(s) 1640. A network interface device, such as any one of network interface device(s) 1640 may be utilized for connecting computing system 1600 to one or more of a variety of networks, such as network 1644, and one or more remote devices 1648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network, a telephone network, a data network associated with a telephone/voice provider, a direct connection between two computing devices, and any combinations thereof. A network, such as network 1644, may employ a wired and/or a wireless mode of communication. In general, any network topology may be used. Information (e.g., data, software instructions 1620, etc.) may be communicated to and/or from computing system 1600 via network interface device(s) 1640.

Computing system 1600 may further include one or more video display adapter 1652 for communicating a displayable image to one or more display devices, such as display device(s) 1636. Examples of a display device include, but are not limited to, a liquid crystal display (LCD), a cathode ray tube (CRT), a plasma display, a light emitting diode (LED) display, and any combinations thereof. Display adapter(s) 1652 and display device(s) 1636 may be utilized in combination with processor(s) 1604 to provide a graphical output. In addition to a display device, computing system 1600 may include one or more other peripheral output devices including, but not limited to, an audio speaker, a printer, and any combinations thereof. Such peripheral output devices may be connected to bus 1612 via a peripheral interface 1656. Examples of a peripheral interface include, but are not limited to, a serial port, a USB connection, a FIREWIRE connection, a parallel connection, and any combinations thereof.

Although not illustrated, another embodiment of a multi-receiver doser of the present disclosure is one in which a doser base and dispensing bin are keyed such that only dispensing bins having a certain type of dispensing mechanism can be used at any particular receiver. For example, fewer than all of the receivers may be configured to drive only rotary-rod based dispensing mechanisms, like dispensing mechanism 500 shown in FIG. 5. However, one or more of the remaining receivers may be configured to drive only a discretizer based dispensing mechanism, such as the dispensing mechanism of dispenser 1200 of FIG. 12. In this example, the receivers for the rotary-rod based dispensing mechanisms and corresponding bins can be uniquely keyed separately from the receiver(s) for the discretizer based dispensing mechanisms, and vice versa, such that the bins having the rotary-rod based dispensing mechanism cannot be engaged with a receiver meant for a discretizer based dispenser and a discretized based dispenser cannot be engaged with a receiver meant for a bin having a rotary-rod based dispensing mechanism. Those skilled in the art will readily appreciate that such a keying system can be similar to keying system 800 of FIG. 8 and alternatives described in connection with that keying system. It is noted that such a doser may also include the additive-identification devices and corresponding readers described above in connection with, for example, FIGS. 11 and 12, for the identification of the exact additives being used with each type of dispensing mechanism.

In still other embodiments, if differing bins having differing dispensing mechanism, such as some that work only with flowable solids, the additive containers and bins can be keyed so that only flowable solid additives can be installed into a bin having a compatible dispensing mechanism. For example, if an auger-type dispensing mechanism is used on a particular bin, that bin and all additive containers can be keyed so that only flowable solid additive containers can be installed in that bin and liquid additive containers cannot. Dosers including such keying may also include the additive-identification devices and corresponding readers described above in connection with, for example, FIGS. 11 and 12, for the identification of the exact additives being used with each type of dispensing mechanism.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A dosing system for adding an additive to an aquatic environment from a removable additive container that includes an additive-identification device, the dosing system comprising:
an additive receiver designed and configured to removably receive the removable additive container;
a dispensing mechanism designed and configured to controllably dispense a desired additive into the aquatic environment when the removable additive container is engaged with said additive receiver;
an additive-presence-detecting device designed and configured to interface with the additive-identification device of the removable additive container so as to identify the additive of the additive container; and
a controller in operative communication with said dispensing mechanism and said additive-presence-detecting device, said controller designed and configured to be responsive to a dosing signal and to the identity of the additive by the additive-presence detecting device so as to control said dispensing mechanism to controllably dispense the desired additive.

2. A dosing system according to claim 1, wherein said controller is designed and configured to control said dispensing mechanism to not dispense the additive from the additive container if the identity of the additive does not correspond to a desired additive called for by the dosing signal.

3. A dosing system according to claim 1, wherein said additive receiver is removable from the dosing system.

4. A dosing system according to claim 1, wherein said additive receiver includes a receptacle that is part of a dispensing bin.

5. A dosing system according to claim 4, wherein said dispensing bin is removable from the dosing system.

6. A dosing system according to claim 1, wherein the dosing system includes a plurality of said additive receiver, each additive receiver associated with a corresponding one of a plurality of said dispensing mechanism and a corresponding one of a plurality of additive-presence-detecting device, each of the plurality of additive-presence-detecting devices in operative communication with said controller so as to allow said controller to identify a corresponding additive present in any additive container positioned in a corresponding one of the plurality of additive receivers.

7. A dosing system according to claim 6, wherein said controller is designed and configured to control the plurality of additive receivers such as to control a select dispensing mechanism corresponding to a select one of the plurality of additive receivers having a desired additive corresponding to a dosing signal.

8. A dosing system according to claim 1, further comprising an additive-quantity-sensing mechanism.

9. A dosing system according to claim 8, wherein said additive-quantity-sensing mechanism includes a dispensing rod of said dispensing mechanism.

10. A dosing system according to claim 8, wherein said additive-quantity-sensing mechanism includes said dispensing mechanism.

11. A dosing system according to claim 1, wherein the dosing signal is based on information from a monitoring device associated with the dosing system, the monitoring device in contact with the aquatic environment to measure one or more parameters of the aquatic environment.

12. A dosing system according to claim 1, wherein the additive is a desired additive and the additive-identification device on the removable additive container includes at least one first key feature unique to the desired additive, and said additive-presence-detecting device includes at least one second key feature designed and configured to uniquely engage with the first key feature to allow the removable additive container to fully engage said additive receiver only if the removable additive container contains, or at one time did contain, the desired additive.

13. A dosing system according to claim 1, wherein the additive-identification device comprises a machine-readable device, and said additive-presence-detecting device includes a reader designed and configured to read the machine-readable device of the removable additive container.

14. A dosing system according to claim 13, wherein the machine-readable device comprises a radio-frequency identification (RFID) device, and said reader comprising an RFID reader located proximate to said additive receiver so as to read the RFID device substantially only when the removable additive container is engaged with said additive receiver.

15. A dosing system according to claim 14, wherein the RFID device on the removable additive container is a writable device, and said RFID reader is designed and configured to write information to the RFID device of the removable additive container.

16. A dosing system according to claim 13, wherein the machine-readable device comprises an optically readable device, and said reader comprising an optical reader located proximate to said additive receiver so as to read the optically readable device substantially only when the removable additive container is engaged with said additive receiver.

17. A dosing system according to claim 13, wherein the machine-readable device comprises a magnetically readable device, and said reader comprising a magnetic reader located proximate to said additive receiver so as to read the magnetically readable device substantially only when the removable additive container is engaged with said additive receiver.

18. A dosing system according to claim 13, wherein the machine-readable device comprises a haptically readable device, and said reader comprising a haptic reader located proximate to said additive receiver so as to read the haptically readable device when the removable additive container is engaged with said additive receiver.

19. A dosing system according to claim 1, wherein said additive receiver includes a piercing structure designed and configured to pierce a wall of an additive container received by the additive receiver when the additive container is properly positioned.

20. A dosing system according to claim 1, wherein said dispensing mechanism includes a dispensing rod.

21. A dosing system according to claim 20, wherein said dispensing rod includes a dosing receptacle.

22. A dosing system according to claim 21, wherein the dispensing receptacle is shaped and configured to reduce the force needed to rotate said dispensing rod.

23. A dosing system according to claim 22, wherein the dispensing receptacle is shaped in a V-shape.

24. A dosing system according to claim 1, further comprising a slotted key mechanism for receiving a finned element of an additive container, wherein said slotted key mechanism is physically associated with said additive receiver to prevent insertion of an additive container into said additive receiver if the additive container includes a finned element that does not match said slotted key mechanism.

25. A dosing system according to claim 24, wherein said slotted key mechanism is removable.

26. A dosing system according to claim 25, wherein said slotted key mechanism includes a slotted insert that is removable from an insert receiver that is part of said additive receiver, the slotted key mechanism including a slotted insert identification device configured to identify an additive corresponding to the slotted insert and said additive receiver includes a slotted insert identification reader for reading the slotted insert identification device.

27.-53. (canceled)
